(19) United States
(12) Patent Application Publication
(10) Pub. No.: US 2024/0303883 A1
(43) Pub. Date: Sep. 12, 2024

(54) METHOD AND APPARATUS FOR GENERATING MODIFIED IMAGES

(71) Applicant: SAMSUNG ELECTRONICS CO., LTD., Suwon-si (KR)

(72) Inventors: Savas OZKAN, Staines (GB); Mete OZAY, Staines (GB); Tom ROBINSON, Staines (GB)

(73) Assignee: SAMSUNG ELECTRONICS CO., LTD., Suwon-si (KR)

(21) Appl. No.: 18/529,533

(22) Filed: Dec. 5, 2023

(30) Foreign Application Priority Data
Mar. 8, 2023 (GB) 2303380.6
Oct. 2, 2023 (GB) 2315096.4

(51) Int. Cl. G06T 11/60; G06V 10/774; G06V 10/778; G06V 10/94; G06V 40/16

(52) U.S. Cl. CPC G06T 11/60; G06V 10/774; G06V 10/7788; G06V 10/945; G06V 40/168; G06V 40/172

(57) ABSTRACT

Broadly speaking, the present techniques generally relate to a method for performing image processing using a machine learning, ML, model. In particular, the present application relates to a method for generating modified images from input images depicting human faces using a trained ML model. Advantageously, the present techniques enable manipulation of human faces within images in a way that allows one aspect of the image of the human face to be altered without impacting other aspects.

### CROSS-REFERENCE TO RELATED APPLICATION(S)

This application is based on and claims priority under 35 U.S.C. § 119(a) of an United Kingdom Provisional Patent Application number 2303380.6, filed on Mar. 8, 2023, in the United Kingdom Intellectual Property Office. and of an United Kingdom Complete Patent Application number 2315096.4, filed on Oct. 2, 2023, in the United Kingdom Intellectual Property Office, the disclosure of which is incorporated by reference herein in its entirety.

### BACKGROUND

### Description of Related Art

The present application generally relates to a method and apparatus for performing image processing using a machine learning, ML, model. In particular, the present application provides a method for generating modified images from input images depicting human faces, using a trained ML model.

Image processing tasks are important applications of modern machine learning, ML, models. From image recognition to image texturization, there is a growing number of areas where ML models are being used for their speed and accuracy. With the rising popularity of virtual reality games and applications like Snapchat in recent years, a class of generative ML models of particular significance is that of so-called face generation models. Generally, face generation models take an input image depicting a human face and generate an output that may be, for example, a 2D/3D avatar or a distorted version of the human face.

Typically, current methods to perform face generation involve processing an input image that depicts a face. However, current methods are unable to edit individual aspects or attributes of an image of a face without interfering or modifying other aspects/attributes. For example, when current methods modify a pose of a face, the expression and likeness of the face may also change. As a result, the output modified face may not resemble the original face, which can be problematic for certain technologies such as avatar generation, facial recognition or digital twin generation.

The present applicant has therefore identified the need for an improved method of performing face generation using ML models.

### SUMMARY

In a first approach of the present techniques, there is provided a computer-implemented method for generating modified images from input images using a trained machine learning, ML, model, the method comprising: obtaining an image depicting at least one human face; and using the trained ML model to: determine, for the obtained image, visual features of one human face in the image; generate, using the determined visual features, at least one representation in vector space which encodes a specific attribute of the human face in the image; modify, in vector space, one or more of the at least one generated representation; and generate, using the or each modified generated representation, a modified image.

The specific attribute of the human face in the image may be any attribute of the human face itself, such as pose or facial expression, or may be any attribute caused by the environment in which the human face is, such as shadows or brightness caused by lighting conditions in the environment.

Advantageously, the present techniques enable manipulation of human faces within images in a way that allows one aspect of the image of the human face to be altered without impacting other aspects. This is advantageous because existing facial image manipulation techniques can cause the human face to look very different overall even though only one aspect of the image of the human face is being changed (e.g. changing a frown to a smile). Existing techniques fail in this way because they cannot edit different aspects of faces simultaneously without interfering with or impacting other aspects. For example, when the post of a head is edited, the expression, illumination and likeness may be affected. This problem occurs because the existing techniques estimate an entangled representation of the image of the face. The present techniques overcome this problem by disentangling the representation, which allows individual aspects of the image of the human face to be edited/modified separately without impacting the other aspects.

The present techniques have a number of uses. For example, it may be desirable to generate a 3D avatar for use in an immersive virtual and/or augmented reality environment. In this case, the present techniques may be used to capture and render a 3D virtual face from a single image of a face of a user. The user may wish to change some aspects of the 3D virtual face, and the present techniques enable this while retaining the likeness of the virtual face to the face in the image. In another example, it may be desirable for users to manipulate or edit human faces in 2D images. This could be to change the facial expression, lighting, identity, pose or other facial features. More generally, the synthesis of 2D or 3D faces from a single image may be used for 3D avatar creation, video editing, image synthesis, digital twin generation, facial recognition, virtual make-up tools (to allow someone to see what certain make-up or cosmetic treatments may look like before applying/undergoing them), speech-driven facial animation, and so on. All of these technologies utilise a 2D or 3D face generation model.

The present techniques allow individual aspects of an image of a face to be edited independently. For example, head pose can be edited without impacting facial expression. The present techniques involve projecting an image into vector space, where the vector space (also referred to herein as representation space) encodes contents or aspects of the image of the face, such as pose, expression, illumination, and likeness. In the present techniques, the representation space is used for editing images of faces and generating new versions of the original image of a face, while enabling human-understandable/human-controllable parameterisation. As noted above, at least one representation may be generated, where each representation encodes a specific attribute. In cases where multiple representations are generated, each representing a different specific attribute, the ML model may be used to modify one or more than one of the representations. That is, it is not necessary to modify all representations that are generated.

The trained ML model comprises an image encoder module, which is trained to determine visual features of a human face in an input image.

The trained ML model comprises a visual representation estimator module, which is trained to generate, using the calculated learned visual features, at least one representation in vector space which encodes a specific attribute of a human face in the input image. The visual representation estimator module may be a transformer-based module.

The trained ML model comprises a visual representation manipulator module, which is trained to modify the at least one representation to thereby modify a specific attribute of a human face in the input image in vector space. The visual representation manipulator module may be a transformer-based module.

The trained ML model comprises an image decoder module, which is trained to generate an output image using the at least one manipulated representation. The output image is a modified version of the input image, in which any specific attribute(s) of the human face in the input image is modified.

The trained ML model may comprise at least one transformer block. Generating the at least one representation may comprise: processing the determined visual features using the at least one transformer block of the ML model, wherein the or each transformer block generates a representation in vector space of a specific attribute. As mentioned above, the generation of the at least one representation may be performed by the visual representation estimator module, which may be transformer-based. Thus, the visual representation estimator module may comprise multiple transformer blocks, where each transformer block is trained to generate a specific representation corresponding to a specific attribute of a human face in images. Therefore, the ML model may comprise a plurality of transformer blocks, and generating at least one representation may comprise using each of the plurality of transformer blocks to generate a representation of different specific attributes of the human face in the image.

Modifying one or more of the at least one generated representation may comprise using a transformer-based face editing module of the ML model to modify, in vector space, at least one specific attribute of the human face. As mentioned above, the modification of the representations may be performed by a visual representation manipulator module.

The step of obtaining an image depicting at least one human face may comprise obtaining an image or a single frame of a video. The present techniques can therefore be used to generate modified images based on either a still image or a frame of a video.

In some cases, the obtained image may depict a single human face. In such cases, as there is only a single human face in the image, there is only one face that can be modified.

In other cases, the obtained image may depict at least two human faces. In such cases, there are multiple possibilities in terms of which face is to be modified.

For example, when an image depicts multiple human faces, the method may comprise: requesting a user to select one of the at least two human faces to modify; and processing, using the ML model, the selected human face. Thus, the user may indicate via a user interface (such as a display), which human face is to be modified.

In another example, when an image depicts multiple human faces, the method may comprise: recognising, using the ML model, a specific user's face as one of the at least two human faces; and processing, using the ML model, the recognised specific user's face. In this example, the ML model itself determines which of the human faces to modify based on which of the human faces belongs to a specific user. The ML model may have learned how to recognise the specific user by being trained (or updated) using images of the specific user.

In another example, when an image depicts multiple human faces, the method may comprise separately processing, using the ML model, each of the at least two human faces. In this example, each face may be modified. The faces may be modified in the same way, such that the method comprises modifying, in vector space, the same at least one generated representation (i.e. the same specific attribute) for each human face. The exact way the at least one generated representation is modified for each human face may be the same or different. For example, the lighting of each human face may be modified in the same way, or the lighting could be made much brighter for one human face than the other. Alternatively, the faces may be modified differently, such that the method comprises modifying, in vector space, a different at least one generated representation (i.e. different specific attributes) for each human face. For example, the light of one human face may be modified, while the pose of another human face may be modified.

The method may further comprise: receiving, from a user, information on at least one specific attribute to be modified, and how the at least one specific attribute is to be modified. Thus, a user may be able to specify which attribute(s) is to be modified and how. Since the modifications take place in representation/vector space, which is not necessarily understandable by most users, the user may be provided with a graphical user interface that enables them to provide this information in a human-understandable manner.

Additionally or alternatively, the method may further comprise: determining, using the ML model, at least one generated representation to be modified to improve an attractiveness score of the image of the human face. In this case, the ML model may determine, based on how the ML model has been trained, to determine how to modify an image to improve the attractiveness score of the human face in the image. For example, the ML model may have been trained on labelled images of human faces, the labels indicating a human-annotated score of the attractiveness of the human face in the image. The human-annotated score of the attractiveness may be based on facial features or characteristics or attributes of the human face, image quality, illumination, pose, etc. The ML model may have learned, from the labelled images, what is considered attractive in images of human faces and therefore, what can be modified to improve the attractiveness. Alternatively, the ML model may have been trained on images of human faces that are considered, by humans or some other means, to be attractive. For example, high levels of facial symmetry are considered in some cultures to be indicative of attractiveness, and the ML model may learn such concepts and use them to determine and improve an attractiveness score of the image of the human face. Of course, what is considered attractive may vary across genders, cultures, ethnicities and countries, and may vary over time, so the ML model may generate different attractiveness scores for users based on where the users are located or other characteristics of the users.

The attractiveness score may be improved based on learned image preferences during training of the ML model. The ML model may be trained to learn representations and preferences that are indicative of attractiveness scores, and may be trained by minimizing a loss function which maximizes the attractiveness score.

Additionally or alternatively, the attractiveness score may be improved based on learning a user's image preferences. In this case, the method may further comprise learning a user's image preferences by: receiving at least one positive sample image of a human face from the user indicative of image preferences the user likes; and/or receiving at least one negative sample image of a human face from the user indicative of image preferences the user dislikes; and learning, using the ML model and the received sample image(s), one or more features of the image of a human face indicative of image preferences. A loss function measuring similarity and dissimilarity between positive and negative samples, such as a contrastive loss, may be used for training the ML model to learn representations of image preferences from negative and positive samples.

One example use case mentioned so far is that of altering a face in an image so that it has desired characteristics or attributes, such as a smile instead of a frown. Another example use case is that of altering a face so that it is anonymised. Instead of simply blurring a face in an image if the user's identity is to be hidden, a face in an image could be modified so that the face can be seen but the user's identity cannot be determined. Thus, the method may further comprise: receiving, from a user, an input indicating that face anonymisation is to be performed; wherein modifying, in vector space, at least one generated representation comprises modifying the at least one generated representation so that the generated modified image comprises an anonymised version of the human face in the obtained image depicting at least one human face.

Another example use case is that of altering an image so that the style of the image and the face in the image is modified. For example, a user may capture a selfie image of themselves and want to modify the image so that it is, for example, in the style of a painting. Thus, the method may further comprise: receiving, from a user, an input indicating a preferred style; wherein modifying, in vector space, at least one generated representation comprises modifying the at least one generated representation so that the generated modified image is in the preferred style. The preferred style of the image is any aesthetic or artistic style, which may be pre-defined. Examples of aesthetic or artistic styles include sketch, cartoon, anime, watercolour, art deco, graffiti, pixel art, oil painting, vintage photo, clip art, and so on. It will be understood that these are non-limiting examples only. The ML model may have learned during training how to modify the at least one generated representation to convert the obtained image into a generated modified image of the preferred style. Specifically, representation of a style s for an input image x may be learned by the ML model during training. The ML model may have an encoder, h, and a decoder, g. The style representations may be learned and encoded by h(x). A representation of a given style s for the given input x may then be obtained by h(x|s) which is conditioning on s. Once these learned representations h(x) are obtained, they can be used with the decoder g by g(h(x)) to generate images. If images in a particular style s are required, then the conditioned and selected representations may be used to do so, by g(h(x|s)).

In a second approach of the present techniques, there is provided a computer-implemented method of training a machine learning, ML, model to generate modified images from input images, the method comprising: receiving a training dataset comprising a plurality of images depicting human faces; training, using the training dataset, a visual representation estimator module of the ML model to generate at least one representation in vector space which encodes a specific attribute of a human face in each image; and training a visual representation manipulator module of the ML model to modify at least one generated representation to thereby modify a specific attribute of the human face in each image.

Generating the at least one representation may comprise training at least one transformer block of the ML model to learn visual features of human faces, where each transformer block generates a representation of a specific attribute. The visual representation estimator module may comprise multiple transformer blocks, where each transformer block is trained to generate a specific representation corresponding to a specific attribute of a human face in images.

Training a visual representation manipulator module of the ML model to modify at least one generated representation may comprise training one or more transformers.

The ML model may comprise an image encoder module, and training the ML model may comprise training the image encoder module to determine visual features of a human face in an input image. These visual features are used by the visual representation estimator module to generate the at least one representation.

The ML model may comprise an image decoder module, and training the ML model may comprise training the image decoder module to generate an output image using the at least one manipulated representation (which is output by the visual representation manipulator module). The output image is a modified version of the input image, in which any specific attribute(s) of the human face in the input image is modified.

In a third approach of the present techniques, there is provided an apparatus for generating modified images from input images using a trained machine learning, ML, model, the apparatus comprising: a display; and at least one processor coupled to memory, for: obtaining an image depicting at least one human face; and using the trained ML model to: determine, for the obtained image, visual features of one human face in the image; generate, using the determined visual features, at least one representation in vector space which encodes a specific attribute of the human face in the image; modify, in vector space, one or more of the at least one generated representation; and generate, using the or each modified generated representation, a modified image.

The features described above with respect to the first approach apply equally to the third approach and therefore, for the sake of conciseness, are not repeated.

The obtained image may depict at least two human faces. In this case, the at least one processor may be further configured to: provide a graphical user interface on the display; and request, via the user interface, a user to select one of the at least two human faces to modify.

The at least one processor may be further configured to: provide a graphical user interface on the display; and request, via the user interface, information on at least one specific attribute to be modified and how the at least one specific attribute is to be modified.

The at least one processor may be further configured to: receive at least one positive sample image from the user indicative of image preferences the user likes and/or receive at least one negative sample image from the user indicative of image preferences the user dislikes; learn, using the ML model, the user's image preferences; and personalise the ML model to process images using the user's image preferences.

In a related approach of the present techniques, there is provided a computer-readable storage medium comprising instructions which, when executed by a processor, causes the processor to carry out any of the methods described herein.

As will be appreciated by one skilled in the art, the present techniques may be embodied as a system, method or computer program product. Accordingly, present techniques may take the form of an entirely hardware embodiment, an entirely software embodiment, or an embodiment combining software and hardware aspects.

Furthermore, the present techniques may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object oriented programming languages and conventional procedural programming languages. Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

Embodiments of the present techniques also provide a non-transitory data carrier carrying code which, when implemented on a processor, causes the processor to carry out any of the methods described herein.

The techniques further provide processor control code to implement the above-described methods, for example on a general purpose computer system or on a digital signal processor (DSP). The techniques also provide a carrier carrying processor control code to, when running, implement any of the above methods, in particular on a non-transitory data carrier. The code may be provided on a carrier such as a disk, a microprocessor, CD- or DVD-ROM, programmed memory such as non-volatile memory (e.g. Flash) or read-only memory (firmware), or on a data carrier such as an optical or electrical signal carrier. Code (and/or data) to implement embodiments of the techniques described herein may comprise source, object or executable code in a conventional programming language (interpreted or compiled) such as Python, C, or assembly code, code for setting up or controlling an ASIC(Application Specific Integrated Circuit) or FPGA (Field Programmable Gate Array), or code for a hardware description language such as Verilog® or VHDL (Very high speed integrated circuit Hardware Description Language). As the skilled person will appreciate, such code and/or data may be distributed between a plurality of coupled components in communication with one another. The techniques may comprise a controller which includes a microprocessor, working memory and program memory coupled to one or more of the components of the system.

It will also be clear to one of skill in the art that all or part of a logical method according to embodiments of the present techniques may suitably be embodied in a logic apparatus comprising logic elements to perform the steps of the above-described methods, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

In an embodiment, the present techniques may be realised in the form of a data carrier having functional data thereon, said functional data comprising functional computer data structures to, when loaded into a computer system or network and operated upon thereby, enable said computer system to perform all the steps of the above-described method.

The method described above may be wholly or partly performed on an apparatus, i.e. an electronic device, using a machine learning or artificial intelligence model. The model may be processed by an artificial intelligence-dedicated processor designed in a hardware structure specified for artificial intelligence model processing. The artificial intelligence model may be obtained by training. Here, “obtained by training” means that a predefined operation rule or artificial intelligence model configured to perform a desired feature (or purpose) is obtained by training a basic artificial intelligence model with multiple pieces of training data by a training algorithm. The artificial intelligence model may include a plurality of neural network layers. Each of the plurality of neural network layers includes a plurality of weight values and performs neural network computation by computation between a result of computation by a previous layer and the plurality of weight values.

As mentioned above, the present techniques may be implemented using an AI model. A function associated with AI may be performed through the non-volatile memory, the volatile memory, and the processor. The processor may include one or a plurality of processors. At this time, one or a plurality of processors may be a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The one or a plurality of processors control the processing of the input data in accordance with a predefined operating rule or artificial intelligence (AI) model stored in the non-volatile memory and the volatile memory. The predefined operating rule or artificial intelligence model is provided through training or learning. Here, being provided through learning means that, by applying a learning algorithm to a plurality of learning data, a predefined operating rule or AI model of a desired characteristic is made. The learning may be performed in a device itself in which AI according to an embodiment is performed, and/o may be implemented through a separate server/system.

The AI model may consist of a plurality of neural network layers. Each layer has a plurality of weight values, and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning algorithm is a method for training a predetermined target device (for example, a robot) using a plurality of learning data to cause, allow, or control the target device to make a determination or prediction. Examples of learning algorithms include, but are not limited to, supervised learning, unsupervised learning, semi-supervised learning, or reinforcement learning.

### BRIEF DESCRIPTION OF THE DRAWINGS

Implementations of the present techniques will now be described, by way of example only, with reference to the accompanying drawings, in which:

FIG. 1A is a schematic diagram showing current methods to map between learned features and parameters of face concepts/attributes;

FIG. 1B is a schematic diagram showing current methods to map between learned features and parameters of present techniques;

FIG. 2 is a schematic block diagram of components of the present ML model;

FIG. 3A is a schematic diagram showing the overall architecture of the visual representation estimator module;

FIG. 3B is a schematic diagram showing the overall architecture of the visual representation estimator module;

FIG. 4 is a schematic diagram illustrating the Transformer-Based Latent Space Controller C(⋅) architecture;

FIG. 5A shows a GAN space χ;

FIG. 5B illustrates a visualization of the intermediate latent space [symbol] with t-SNE;

FIG. 6(step1, step2) shows a schematic diagram of how the present model is trained using two main stages;

FIG. 7A shows examples in which pose is changed;

FIG. 7B shows examples in which expression is changed;

FIG. 7C shows examples in which illumination has changed;

FIG. 8 shows results of experiments performed on images of real faces;

FIG. 9 is a table showing results of experiments to determine face identity similarity scores when one or more attributes are modified;

FIG. 10 is a table showing results of experiments conducted on modifying illumination;

FIG. 11 is a table showing results of experiments to evaluate the present techniques using Basel model outputs;

FIG. 12A shows results of experiments to analyse the intermediate latent space;

FIG. 12B shows results of experiments to analyse the intermediate latent space;

FIG. 12C shows results of experiments to analyse the intermediate latent space;

FIG. 13A shows results of experiments to analyse the property of mutually exclusive and conceptually consistent representations;

FIG. 13B shows results of experiments to analyse the property of mutually exclusive and conceptually consistent representations;

FIG. 13C shows results of experiments to analyse the property of mutually exclusive and conceptually consistent representations;

FIG. 14 is a schematic diagram of an example process to use the present techniques to generate modified images;

FIG. 15 is a schematic diagram of another example process to use the present techniques to generate modified images;

FIG. 16 is a schematic diagram of another example process to use the present techniques to generate modified images;

FIG. 17 is a flowchart showing example steps for generating modified images from input images using the present trained machine learning, ML, model;

FIG. 18 is a flowchart showing example steps for training the ML model of the present techniques; and

FIG. 19 is a block diagram of an apparatus 200 for using a trained machine learning, ML, model for generating modified images.

### DETAILED DESCRIPTION

Broadly speaking, the present techniques generally relate to a method for performing image processing using a machine learning, ML, model. In particular, the present application relates to a method for generating modified images from input images depicting human faces using a trained ML model. Advantageously, the present techniques enable manipulation of human faces within images in a way that allows one aspect of the image of the human face to be altered without impacting other aspects.

Generative Adversarial Networks (GANs) can produce photo-realistic results using an unconditional image-generation pipeline. However, the images generated by GANs (e.g., StyleGAN) are entangled in latent spaces, which makes it difficult to interpret and control the contents of images. To address this, the present applicant adopts an encoder-decoder model that decomposes the entangled GAN space into a conceptual and hierarchical latent space in a self-supervised manner. The outputs of 3D morphable face models are leveraged to independently control image synthesis parameters like pose, expression, and illumination. For this purpose, a novel latent space decomposition pipeline is adopted using transformer networks and generative models. The novel latent space is used to optimize a transformer-based GAN space controller for face editing. The present applicant utilizes a StyleGAN2 model for faces. Since the present techniques manipulate only GAN features, the photo-realism of StyleGAN2 is fully preserved. The results demonstrate that the present techniques qualitatively and quantitatively outperform baselines in terms of identity preservation and editing precision.

Generative adversarial networks (GANs) are formulated as a two-step learning procedure via generator and discriminator models. This pipeline can produce photo-realistic images that are hard to distinguish. In particular, generative models such as StyleGAN2 have become one of the most effective image synthesis tools. They are capable of generating high-resolution images using nonlinear features learned from low-dimensional feature spaces. Ultimately, coarse and fine details of synthesized images are simply derived from these spaces. However, existing GAN models do not offer intuitive control, i.e., not human understandable parameterization, for image generation. Recent works have shown that the outputs of GAN models can be edited by disentangling their latent spaces without the need of employing full supervision or updating pre-trained model parameters.

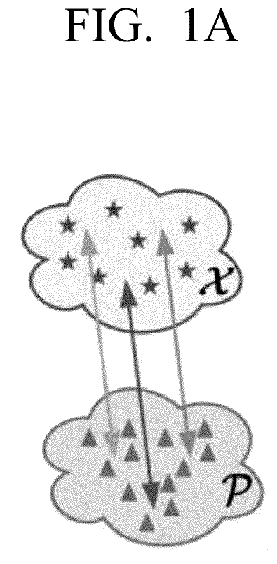

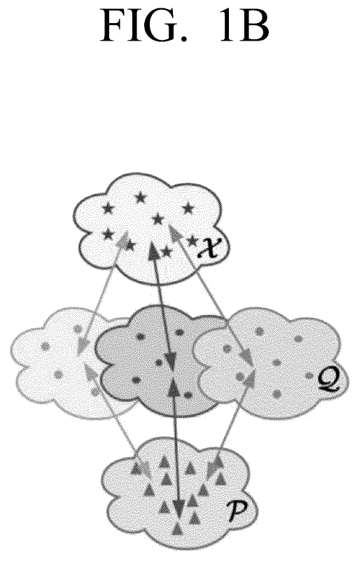

There have been multiple efforts in the literature to achieve controllable content manipulation of features of GANs with supervised and unsupervised learning methods. FIG. 1 is a schematic diagram showing current methods to map between learned features and parameters of face concepts/attributes (1A), and the present techniques (1B). Current methods (1A) use labelled data to expand user control onto a GAN space of features (depicted by χ in FIGS. 1A and 1B). These labels are used to decouple the entangled representations with learnable projections. However, this control needs costly manual annotations that usually involve gathering many images and labels with clear definitions. Hence, performance is significantly impacted by the total number of annotations and the quality of labels. In contrast to the supervised methods, unsupervised approaches achieve disentanglement by finding principle directions in latent spaces without relying on labelled data. Ultimately, each direction alters a different visual content so that a semi-automatic control is provided for the existing GAN models. Other studies have suggested that manipulating the GAN spaces may be limited by biases present in pre-trained models. Hence, their goal is to train a new generator model from scratch using generative priors for controllable image synthesis. Although the models have robust control over the feature space, they are difficult and costly to train.

An alternative to face editing uses attributes such as pose, light, expression, and likeness, derived from 3D Morphable face models as pseudo-labels. Each attribute has a unique parameter set, and these parameters are used as pseudo-labels to disentangle a pre-trained GAN space. For this purpose, the present applicant proposes a model (called differentiable face reconstruction (DFR)) and fix the original GAN parameters. Thus, as shown in FIGS. 1A and 1B, instead of finding a direct mapping between a GAN space χ of learned features (stars) and a space of parameters [symbol] of face concepts (triangles) (which is on the lefthand side of the Figure), the present techniques (righthand side) estimate an intermediate latent space [symbol] whose latent codes (circles) are conceptual and hierarchical. This is because a GAN space controller trained on this space can edit each concept independently while preserving the details at different abstraction levels of GANs for face editing.

The present applicant proposes a novel method to manipulate GAN spaces for face editing. For this purpose, the present applicant proposes an encoder-decoder machine learning, ML, model that estimates an intermediate latent space ( [symbol] ) while learning a mapping between a GAN space χ and a face parameter space P. The model estimates an intermediate latent space [symbol] while learning a mapping between a GAN space χ and a face parameter space P. Compared to the current baseline, employment of this new space is crucial since it derives hierarchical and conceptual latent codes for further usages. In other words, face attributes are independently represented while hierarchical details at different abstraction levels of GANs are maintained. These latent codes are used to learn controlling a GAN space for face editing. Pseudo-labels estimated by 3D morphable models are used, and the present techniques do not require the updating of the GAN models.

The present techniques have two main components. (i) A transformer-based latent code decomposer that computes conceptual and hierarchical latent codes from a GAN space χ of features, and the parameters of face attributes from P. A novel encoder-decoder model is proposed to compute intermediate latent codes, with an encoder model based on transformer networks. These intermediate latent codes are then reprojected to the face parameter space [symbol] using a multi-resolution generative model. The present techniques perform the decomposition in a self-supervised manner during the space mapping, relying solely on the reconstruction error at the output of our model. (ii) A GAN space controller that manipulates GAN space χ of features with face control parameters. To optimize the model, the present applicant enforces the consistency between the projected representations of the original and manipulated GAN features on the intermediate latent space [symbol] . The model is based on a transformer network that uses face control parameters to manipulate the GAN space χ.

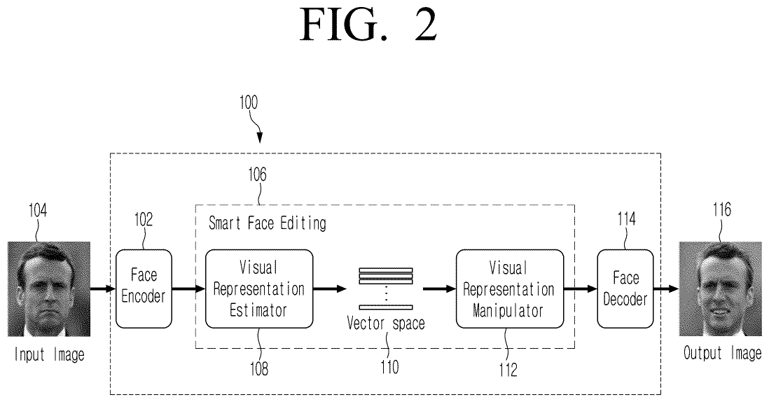

FIG. 2 is a schematic block diagram of components of the present ML model 100.

The ML model 100 comprises an image encoder module 102, which is trained to determine visual features of a human face in an input image (such as image 104).

The ML model 100 comprises a smart face editing module 106. The smart face editing module 106 comprises a visual representation estimator module 108, which is trained to generate, using the calculated learned visual features, at least one representation in vector space 110 which encodes a specific attribute of a human face in the input image. The visual representation estimator module 108 may be a transformer-based module.

The smart face editing module 106 comprises a visual representation manipulator module 112, which is trained to modify the at least one representation to thereby modify a specific attribute of a human face in the input image in vector space 110. The visual representation manipulator module 112 may be a transformer-based module.

The ML model 100 comprises an image decoder module 114, which is trained to generate an output image using the at least one manipulated representation. The output image 116 is a modified version of the input image 104, in which any specific attribute(s) of the human face in the input image is modified.

The ML model 100 enables individual aspects of an image of a face to be edited independently. For example, head pose can be edited without impacting facial expression. The present techniques involve projecting an image into vector space, where the vector space (also referred to herein as representation space) encodes contents or aspects of the image of the face, such as pose, expression, illumination, and likeness. In the present techniques, the representation space 110 is used for editing images of faces and generating new versions of the original image of a face, while enabling human-understandable/human-controllable parameterisation.

The input into the ML model 100 is an image 104. The image may be a single image. Alternatively, the image may be a single frame of a video. Typically, an image has more than one attribute. As mentioned above, examples of such attributes include pose, expression, and illumination. By encoding a specific attribute into a representation in vector space 110, the attributes are disentangled. That is, the intermediate representation in vector space 110 ensures that the attributes can be modified individually without interfering with one another.

The at least one generated representation in vector space 110 is modified by the visual representation manipulator module 112. The modification of the generated representation, by virtue of its encoding of a specific attribute in vector space, means that the image is modified with respect to the encoded attribute. Therefore, the attributes of the image that have not been encoded to a representation in vector space are not modifiable. For example, in the case that the attribute to be modified is illumination, the present techniques enable modification of the illumination, while other image attributes are not modified. The modified generated representation is used by the face decoder 114 to generate a modified output image 116.

The visual representation estimator module 108 may comprise multiple transformer blocks, where each transformer block is trained to generate a specific representation corresponding to a specific attribute of a human face in images. Thus, generating the at least one representation may comprise processing the determined visual features using at least one transformer block of the ML model, wherein each transformer block generates a representation of a specific attribute of the human face in the image.

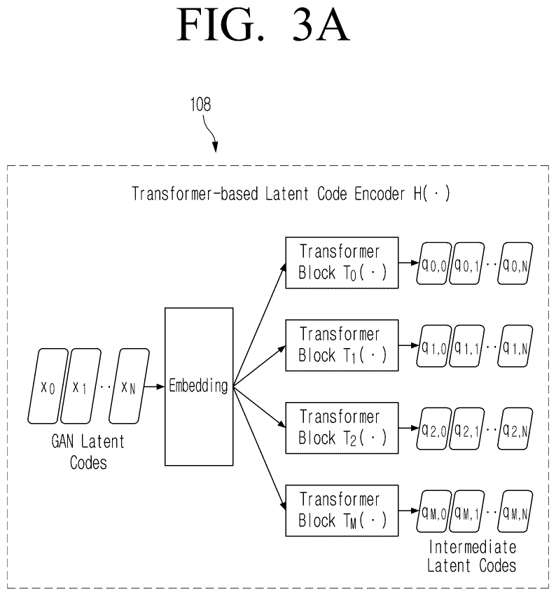

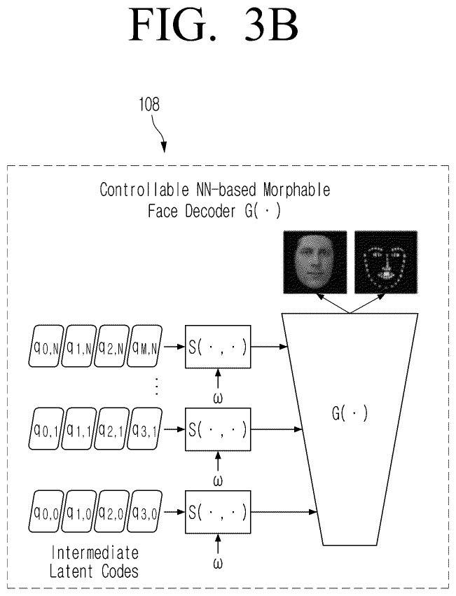

The architecture of the ML model is now described in more detail with reference to FIGS. 3(3A and 3B) and 4.

GAN space χ: In GANs, a feature z is sampled from a probability distribution p(z). A NN model G(⋅) is utilized to synthesize an image I_{z}∈ [symbol] ^{3×h×w} from the feature by I_{z}=G(z). In several GANs, such as StyleGAN, a multi-resolution feature obtained from various abstraction levels x=[xᵢ∈ [symbol] ^{d}]ᵢ₌₁^{N}, is computed with nonlinear fully-connected networks by x=V(z). To this end, both theoretical and algorithmic improvements enable the generation of high-quality and high-resolution images (configuration of StyleGAN is w=h=1024, N=18 and d=512).

In StyleGAN, utilization of “style mixing” regularization during training aims to find a multi-resolution GAN space χ where the feature xᵢ∈χ at the i^{th} abstraction level enforces to scatter its own details to the overall image content. In other words, image content can be manipulated by simply swapping or editing GAN features at different abstraction levels. However, since these features are entangled, this manipulation operation is not controllable.

Parameter space [symbol] : In 3D morphable face models an input face can be represented by a set of attributes p=(β, ψ, θ, γ, R, t)∈ [symbol] ^{t}. Here, each term denotes a face attribute such as the facial shape β, the skin texture/reflectance ψ, the facial expression θ, the scene illumination γ, the head pose rotation R and translation t. In these models, each attribute can be independently controllable. Thereby, various face combinations Iₚ=R(p) can be derived (with a differentiable renderer R(⋅)) by sampling a parameter tuple p from a face parameter space [symbol] =UM, ∪ᵢ₌₁^{M} [symbol] ᵢ. Here, M denotes the number of attributes and [symbol] ᵢ denotes the i^{th} sub-attribute space. Beyond this, efforts are also made towards estimating these parameters from real images I_{f} using an encoder model E(⋅) by p_{f}=E(I_{f}).

In a self-supervised learning setup, the present method first learns an intermediate latent space [symbol] that represents both hierarchical and conceptual information existing in χ and [symbol] , respectively. Then, this space is used to obtain an optimum GAN space controller for face editing.

The baseline method computes a model f that maps a GAN space χ onto a face parameter space [symbol] by f:x∈χ [symbol] p∈ [symbol] . Later, the space [symbol] is used to optimize a GAN space controller (i.e., an encoder-decoder model) for face editing. However, the space [symbol] encapsulates only the conceptual information so that the hierarchical information in χ is eventually degraded during manipulation.

Therefore, the objective of the present techniques is first to find an intermediate latent space [symbol] in the course of transforming the space χ to the space [symbol] with a set of models by ϕ:χ→ [symbol] → [symbol] . After all, instead of the space [symbol] , intermediate latent space 2 is employed for the optimization of the controller model. This space essentially must comprise two properties to overcome the weakness of the baseline method:
1. Employment of hierarchical representations: At each abstraction level, representations with different levels of detail are learned and encoded in GAN spaces. In order to preserve these varying details and information granularity for face editing, they must be projected to a hierarchical intermediate latent space in training.
2. Mutually exclusive and conceptually consistent representations: In order to control generating faces for different attributes, each attribute must be represented by a unique sub-space with distinct and diverse characteristics. Therefore, the representations of attributes must be mutually independent.

To achieve these properties while learning the intermediate latent space [symbol] , a latent space decomposition method is proposed that is formulated by encoder-decoder mapping functions h:χ→ [symbol] and g: [symbol] → [symbol] which decompose ϕ(x)=g·h(x). Briefly, h(⋅) denotes a transformer-based latent space encoder, and g(⋅) represents a controllable NN-based morphable face decoder.

FIG. 3(3A and 3B) is a schematic diagram showing the overall architecture of the visual representation estimator module 108. As noted above, generating the at least one representation may comprise processing the determined visual features using at least one transformer block of the ML model, wherein each transformer block generates a representation of a specific attribute of the human face in the image. The visual representation estimator module 108 comprises these transformer blocks, as shown in FIG. 3(3A and 3B). The visual representation estimator module 108 may comprise an encoder and a decoder. As shown in FIG. 3(3A and 3B), the visual representation estimator module 108 may comprise a transformer-based latent code encoder and a controllable neural network based morphable face decoder, which are used to estimate the intermediate latent codes q in a self-supervised manner.

The Transformer-based Latent Space/Code Encoder (TLSE) on the left-hand side of FIG. 3(3A and 3B) is now described. Given a multi-resolution feature x, a function is learned to decompose it into conceptual (M dimensional) and hierarchical (N dimensional) codes by Q=H(x) where Q=[Q_{i,j}∈ [symbol] ^{k}]_{i,j=1}^{M,N}. These decomposed codes should capture information from both face parameter and GAN spaces. In other words, they must be conceptual and hierarchical. These codes are then used to train a GAN space controller for face editing by measuring the hierarchical and conceptual consistencies between original and manipulated latent codes.

In practice, the present model first projects each GAN feature obtained at the i^{th} abstraction level xᵢ to M different codes [e_{j,i}]ⱼ₌₁^{M} using different linear layers by e_{j,i}=Wⱼxᵢ. As a result, each code e_{j,i} represents an embedding of one of the face attributes. Later, we arrange these embeddings to create a code sequence [e_{j,i}]ⱼ₌₁^{N} for each attribute and feed them to multiple transformer networks. To this end, M different transformer blocks are trained for each attribute [Tᵢ(⋅)]ᵢ₌₁^{M}. FIG. 3(3A and 3B) schematically illustrates the encoder. Transformers are particularly selected for their ability to unveil the hierarchical dependencies among inputs (property 1).

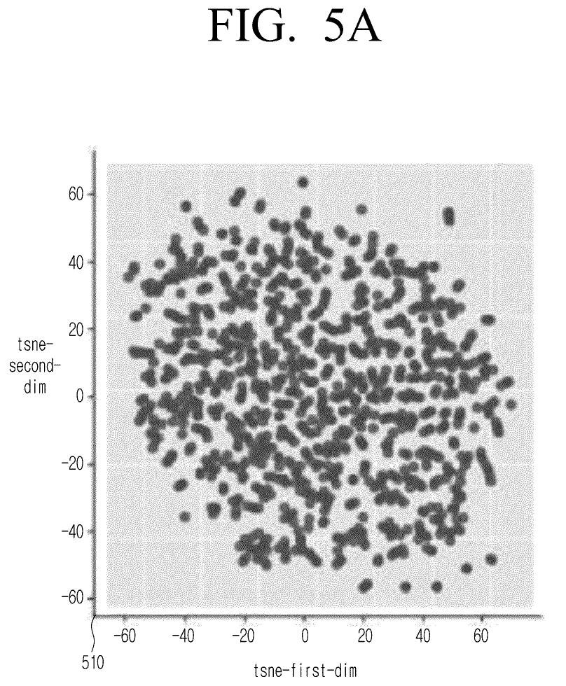

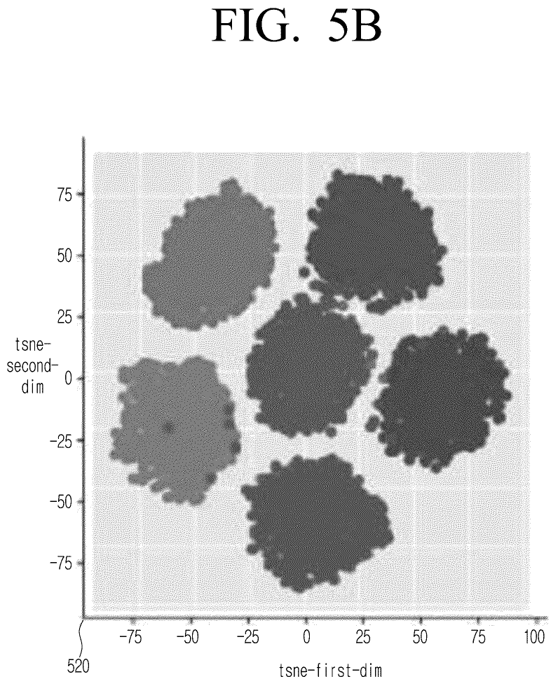

Furthermore, the codes are deliberately separated for each attribute to achieve independent control for the GAN space (property 2). Graph 510 of FIG. 5A shows a GAN space χ and Graph 520 of FIG. 5B illustrates a visualization of the intermediate latent space [symbol] with t-SNE. Intermediate latent space [symbol] contains disentangled representations that cover multiple and independent sub-spaces (separated regions) by [symbol] =∪ᵢ₌₁^{M} [symbol] ᵢ (M=6 in FIG. 5B), while the GAN space χ is entangled.

Returning to FIG. 3(3A and 3B), the right-hand side, which shows the Controllable Neural-Network-based Morphable Face Decoder (CMFD) is now described. Unsupervised learning of the intermediate latent space [symbol] is a challenging task. To be specific, there is no labeled data obtained from the intermediate latent space (neither supervised nor pseudo labels). Therefore, one of the properties of 3D morphable face models must be leveraged with multi-resolution generative models where the generator produces a single image output using a multi-resolution representation. Here, 3D morphable face models are used as a relaxed data generation pipeline for the generative model, since multiple face renderings can be generated for the same person by preserving or discarding some of the facial attributes.

For this purpose, the present applicant proposes a controllable NN-based morphable face encoder model, and a scheme to train the model. This model aims to find a projection between the hierarchical intermediate latent space [symbol] and conceptual face parameter space [symbol] , and train the parameters of the TLSE. Hence, it is a function that synthesizes a rendered morphable face and facial landmarks projected onto a 2D binary image using intermediate latent codes Q by [I_{Q}, L_{Q}]=G(Q) where I_{Q}∈ [symbol] ^{3×h×w} and L_{Q}∈ [symbol] ^{1×h×w}. In essence, this model serves as a differentiable renderer, but it receives multi-resolution latent codes. Here, the rendered images also do not need to be high-resolution (i.e., h<<1024, w<<1024, and we use h=w=64 in our experiments). The architecture of the generative model is based on Ivan Anokhin et al, where pixel coordinates are encoded with latent Fourier blocks. This provides two advantages: 1) it encodes the geometric properties better, and 2) it represents the higher frequency content better. Indeed, a differentiable renderer model is required (that is, the renderer in 3D morphable face models is used) R: [symbol] ^{l}→ [symbol] ^{3×h×w} to generate ground-truth renders and optimize the present models. Note that its parameters are also fixed.

Furthermore, the present applicant introduces a stochastic sampler S(⋅,⋅) to be used for both intermediate latent codes \tilde{Q}=S(Q, ω) and face attribute parameters p=S(p, ω). Here, this function stochastically activates (preserves codes) or deactivates (codes are set to zero) some of the attributes with a random binary mask ω∈ [symbol] ^{M} at each training iteration. Specifically, this regularization method provides a better conceptual decomposition for intermediate latent codes by randomly combining/dropping some of face attributes at each iteration. For the sake of simplicity of the notation, we will denote p and Q instead of \tilde{p}, \tilde{Q} from now on. The decoder model is visually summarized in FIG. 3. Both H and G models are trained with the following loss [symbol] ₐₗₗ;

$${ℒ}_{all} = {ℒ}_{photo} ( {I}_{Q} , p ) + {ℒ}_{land} ( {L}_{Q} , p ) + {λ}_{gan} {ℒ}_{gan} ( {I}_{Q} , {L}_{Q} , p ) + {λ}_{orth} {ℒ}_{orth} ( W ) ,$$

where λ_{gan} and λₒᵣₜₕ are regularization parameters. The pixel-wise photometric loss is defined as the Euclidean distance (∥⋅∥₂) between face images rendered by our generative model and differentiable renderer model by

$${ℒ}_{photo} ( {I}_{Q} , p ) = {‖ {I}_{Q} - R ( p ) ‖}_{2} . \qquad ( 1 )$$

Landmark loss is also adapted to enhance face renders for the attributes related to face meshes like expression and head pose using a pixel-wise binary-cross entropy loss by

$${ℒ}_{land} ( {L}_{Q} , p ) = {L}_{r} log ( {L}_{Q} ) + ( 1 - {L}_{r} ) log ( 1 - {L}_{Q} ) \qquad ( 2 )$$

where Lᵣ∈ [symbol] ^{1×h×w} denotes the landmark positions that are computed using the attribute parameters p and then projected onto a 2D binary image with a differentiable face renderer.

To find the association of the rendered images and landmark positions in the intermediate latent space, the present applicant introduces a GAN-based penalty term:

$${ℒ}_{gan} ( {I}_{Q} , p ) = log ( 1 - D ( {I}_{Q} , {L}_{r} ) ) , \qquad ( 3 )$$

where, D(⋅,⋅) denotes a conditional discriminative network. To ensure the conceptual independence for the intermediate codes, an orthogonal regularization term is incorporated by

$${ℒ}_{orth} ( W ) = {‖ {WW}^{T} - 𝕀 ‖}_{1} , \qquad ( 4 )$$

where ∥ denotes the identity matrix and ∥⋅∥₁ is the l₁ norm.

Latent space face editing with transformers. For each multi-resolution GAN feature x, a synthetic image can be generated using a pre-trained GAN model by Iₓ=σ(x) (σ is implemented using StyleGAN2 in the following analyses). The present applicant aims to edit a GAN feature x using a control parameter pₑ and a trainable controller c by where xₑ and Δxₑ=C(x, pₑ) denote the edited GAN feature and residual feature, respectively. An image for the edited feature can be also generated by Iₓ_{ₑ}=0(xₑ).

For this purpose, the present applicant proposes a transformer-based GAN space controller C(x, pₑ). Since the control face parameter pₑ is a single variable, decompose the vector representation is decomposed into level-wise representations with a multi-head self-attention. Next, a multi-head attribute attention is designed that intuitively manipulates the GAN features with the face control parameters. Compared to self-attention models, the query is projected from GAN features x, while key and value are computed from control face parameters pₑ.

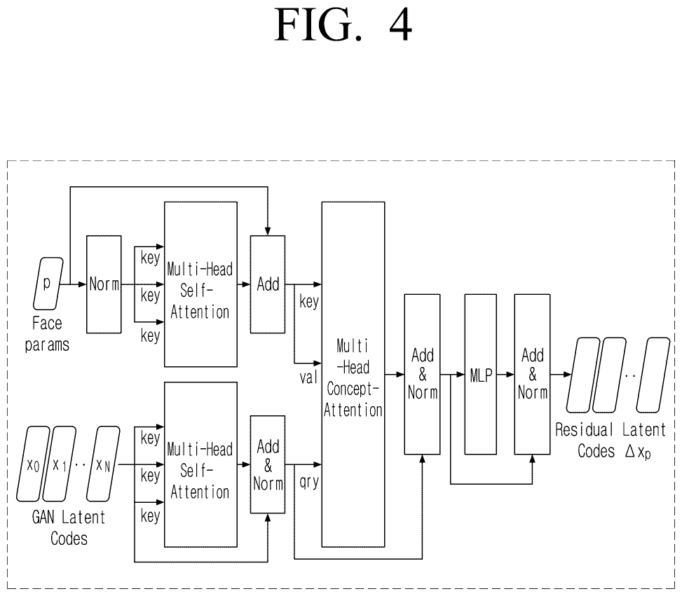

FIG. 4 is a schematic diagram illustrating the Transformer-Based Latent Space Controller C(⋅) architecture. Compared to baseline, the fully-connected encoder-decoder baseline model, this model can capture hierarchical dependencies at multiple abstraction levels during the manipulation step. As a result, the model can learn these dependencies and can edit the coarse, medium, and fine details in the GAN space using control parameters.

Optimization. Given the GAN feature and face parameter pairs (x₁, pₓ_{₁}) and (x₂, pₓ_{₂}), the controller is optimized without using ground-truth labels. During training, a random binary mask ω∈0, 1^{M} is sampled at each iteration. A new control parameter pₑ is calculated as a linear mixture of pₓ_{₁} and pₓ_{₂} by pₑ=ωpₓ_{₁}+(1−ω)pₓ_{₂}. Next, the feature x₁ is edited by the parameters pₑ to estimate x_{1→e}. The controller C(⋅,⋅) is trained by minimizing the conceptual dissimilarity between the original and manipulated latent codes with the following loss

$${ℒ}_{consist} = {‖ S ( H ( {x}_{1} ) , ω ) - S ( H ( {x}_{1 \to e} ) , ω ) ‖}_{1} + {‖ S ( H ( {x}_{2} ) , 1 - ω ) - S ( H ( {x}_{1 \to e} ) , 1 - ω ) ‖}_{1} + {λ}_{edit} {‖ {x}_{1} - {x}_{1 \to e \to 1} ‖}_{2} + {λ}_{sparse} {‖ Δ {x}_{e} ‖}_{1} ,$$

where, S(⋅,⋅) and H(⋅) denote the stochastic sampler and a pre-trained TLSE model presented previously. λ_{edit} is the coefficient that scales effects of cycle-consistency loss, and λₛₚₐᵣₛₑ is used to control the sparsity of disentanglement.

Multi-Task Learning: The consistency loss used in the present model can be separately calculated for each attribute. To be specific, the mean absolute error between the outputs of the pre-trained TLSE H(⋅) employed using the original and edited codes can be computed for each attribute. Thereby, the optimization step is formulated in a multi-task learning setting to prevent overfitting to a particular attribute during training. An uncertainty-based multi-task learning method is utilized to better learn shared representations by scaling the loss objectives for each attribute, and by mitigating the sensitivity for weight selection.

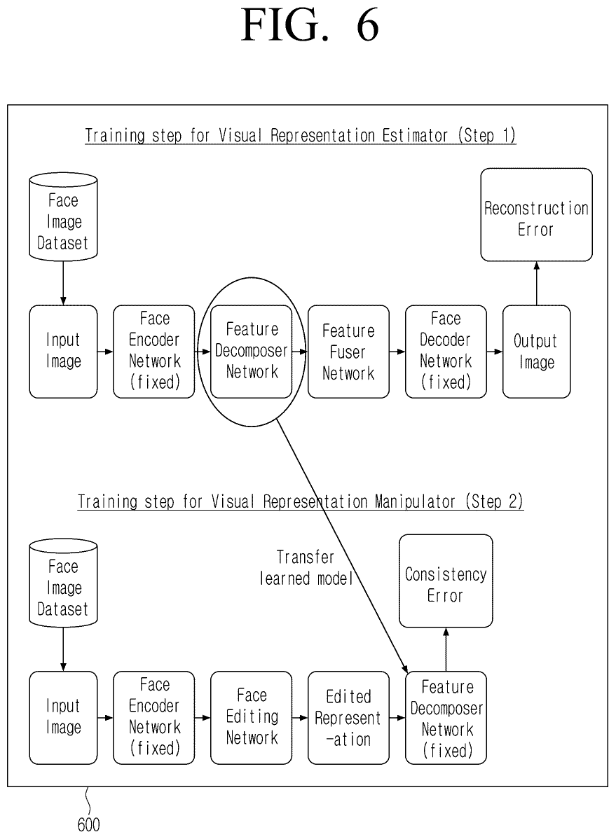

Implementation Details: Embodiment 600 of FIG. 6 shows a schematic diagram of how the present model is trained using two main stages. The method of training the present model to generate modified images from input images comprises: receiving a training dataset comprising a plurality of images depicting human faces; training, using the training dataset, a visual representation estimator module of the ML model to generate at least one representation in vector space which encodes a specific attribute of a human face in each image (step 1 in FIG. 6A); and training a visual representation manipulator module of the ML model to modify at least one generated representation to thereby modify a specific attribute of the human face in each image (step 2 in FIG. 6B). As shown in FIG. 6, once the visual representation estimator module has been trained, it is fixed while the visual representation manipulator module is trained.

Generating the at least one representation may comprise training at least one transformer block of the ML model to learn visual features of human faces, where each transformer block generates a representation of a specific attribute. The visual representation estimator module may comprise multiple transformer blocks, where each transformer block is trained to generate a specific representation corresponding to a specific attribute of a human face in images.

Training a visual representation manipulator module of the ML model to modify at least one generated representation may comprise training one or more transformers.

The ML model may comprise an image encoder module, and training the ML model may comprise training the image encoder module to determine visual features of a human face in an input image. These visual features are used by the visual representation estimator module to generate the at least one representation.

The ML model may comprise an image decoder module, and training the ML model may comprise training the image decoder module to generate an output image using the at least one manipulated representation (which is output by the visual representation manipulator module). The output image is a modified version of the input image, in which any specific attribute(s) of the human face in the input image is modified.

More details on the training process are now provided. The model is trained using the LAMB optimizer with a learning rate of 0.0032, a batch size of 1024 and an iteration of 40K. For the transformers implementing the model H(⋅), the architecture presented in A. Dosovitsky et al. (2 layers with 8 multi-heads). For the transformer implementing C(⋅),4 layers with 8 multi-heads are used. Training time for the present pipeline approximately takes 1 hour with multiple GPUs. Empirically, the dimension of intermediate codes k is set to 16. In addition, λ_{gan}, λₒᵣₜₕ, λ_{edit} and λₛₚₐᵣₛₑ coefficients are set to 0.01, 1e−4, 0.01 and 1e−4, respectively.

Dataset: A StyleGAN2 model trained on FFHQ dataset is used in all of the following experiments. For this purpose, the pipeline requires StyleGAN2 features and corresponding 3D morphable face parameters for training. Therefore, 200K features from StyleGAN2 space are randomly sampled, where 190K is reserved for training and the rest is used for testing. To increase the diversity of facial patterns, up to 5 separate features are combined to produce one feature, leveraging the idea of style mixing. To implement a 3D morphable model and estimate the face parameters, a NN-method based on the Basel Face model is used. Note that the approach of the present applicant was tested with FLAME face model computed by DECA, and still, equivalent results are obtained. To compare the present techniques with baselines, a synthetic dataset released by StyleFlow is used for qualitative and quantitative evaluations.

Baselines: As baselines, the present techniques are compared with five works: InterfaceGAN (IG), GANSpace (GS), SeFa, StyleRig (SR) and StyleFlow (SF). For GS, SeFa and SF, the code provided by the authors was used. For IG, previously reported results and the code provided for limited attributes was used. Lastly, the SR model was implemented from scratch based on their paper.

Metrics: The results of the present techniques were evaluated using face identity, edit consistency and edit precision scores on the StyleFlow dataset. To reproduce the same results, the embeddings of a face model on the original and edited images are used to calculate the cosine similarity for face identity scores. Furthermore, the edit permutation consistency is reported only for the light parameter attribute with DPR model (for other attributes, attribute model is not open-sourced, so is was not possible ro report any scores). Lastly, the facial attributes between source and target images are swaooed to transfer expression, pose and illumination attributes. The mean error between the edited and target images using Basel model outputs for edit scores was calculated.

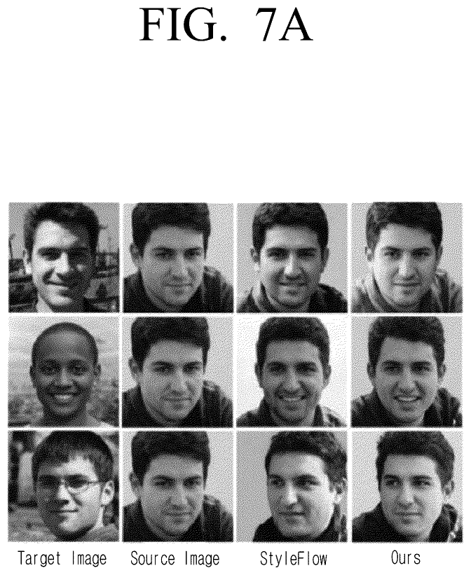

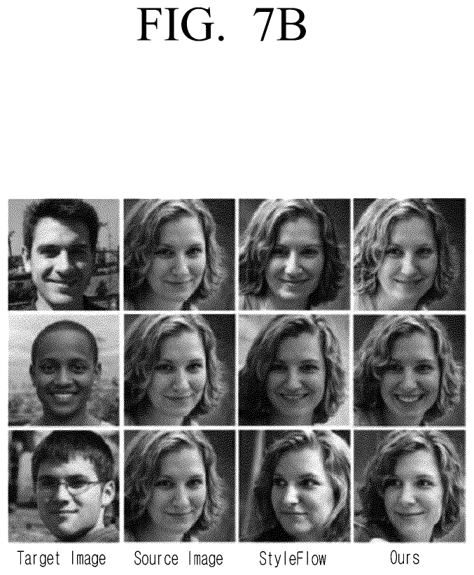

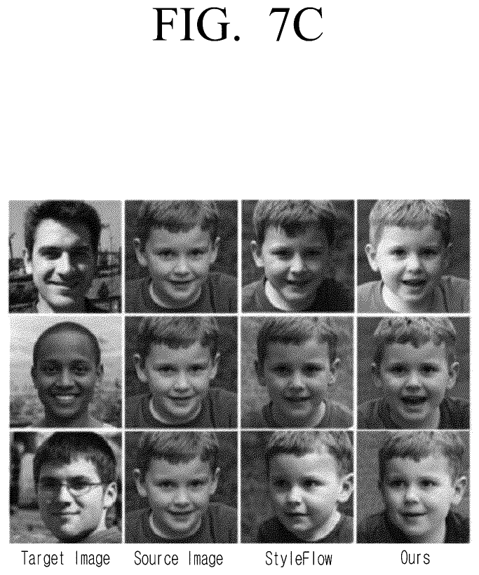

To demonstrate the ability of the present techniques to produce high-quality disentangled image edits, tests were conducted by transferring face parameters (i.e., pose, expression, and illumination) from target images to source images. Results are illustrated in FIGS. 7A to 7C. FIG. 7A shows examples in which pose is changed, FIG. 7B shows examples in which expression is changed, and FIG. 7C shows examples in which illumination has changed. The results indicate that the present techniques can successfully handle extreme changes in pose, expression, and illumination. Notably, the approach of the present applicant preserves other attributes such as background, clothing, and hair color from the source images. This characteristic is achieved by utilizing mutually independent latent codes during optimization, which ensures that other attributes remain unaffected in the GAN space manipulation.

The results of the present techniques are compared with the reported SF results. However, the baseline model cannot adequately preserve face identity for extreme pose and illumination changes (as seen in the left-column face set-last row). Furthermore, there are significant pose and expression misalignments between the target and SF-edited images. Lastly, altering face attributes with SF leads to undesired changes on face attributes such as age (as seen in the right-column face set, last row). Note that SR results are not included in this discussion since previous work has already indicated that the model does not perform well when all face attributes are simultaneously applied.

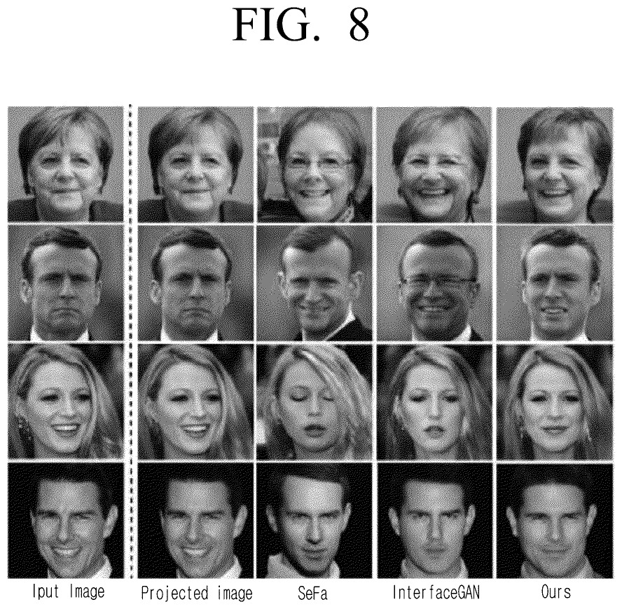

In practice, editing real faces is essential for the final application. Hence, the results on real faces are shown in FIG. 8. FIG. 8 shows results of experiments performed on images of real faces. Real faces are first projected to StyleGAN. The present techniques are compared with IG model, whose implementation is shared with the same model that only allows to edit pose and expression attributes, and SeFa model. The results demonstrate that the present techniques give significantly better results compared to IG and SeFa in terms of reducing distortion (first row), preserving attributes and identities (first, second and fourth rows), and producing realistic expressions (third row).

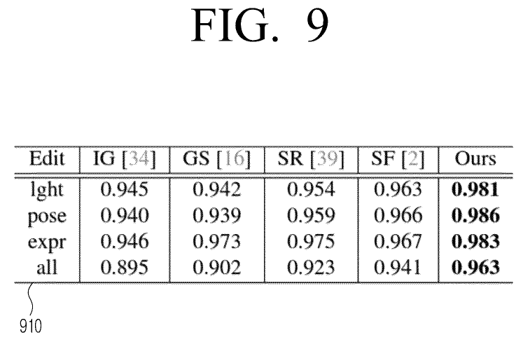

To support the results, the present techniques are evaluated with the quantitative analyses. FIG. 9 is a table(910) showing results of experiments to determine face identity similarity scores when one or more attributes are modified. The face identity similarity score is higher when the similarity of the face in the modified image is close to the face in the original input image. As shown in FIG. 9, the experiments were conducted by modifying illumination (illum), pose, expression (expr) and all three attributes simultaneously (all). The present techniques yield significantly better results in terms of identity scores compared to baselines. The results show that the present techniques only manipulate the targeted part(s) without changing identities.

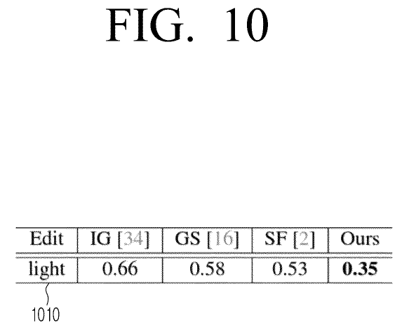

FIG. 10 is a table(1010) showing results of experiments conducted on modifying illumination. It can be seen that the present techniques only manipulate the targeted attribute(s) property. In the experiments, the cycle edit consistency between sequentially transferred light-expression and pose-light attributes for the same person is measured. The error is significantly reduced due to the conceptually independent latent space.

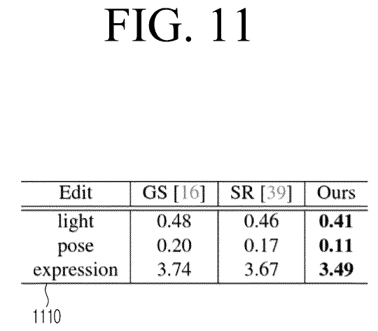

FIG. 11 is a table(1110) showing results of experiments to evaluate the present techniques using Basel model outputs. The table reports the mean absolute error. Again, the present techniques demonstrate superior performance for the manipulation of illumination, expression and pose parameters.

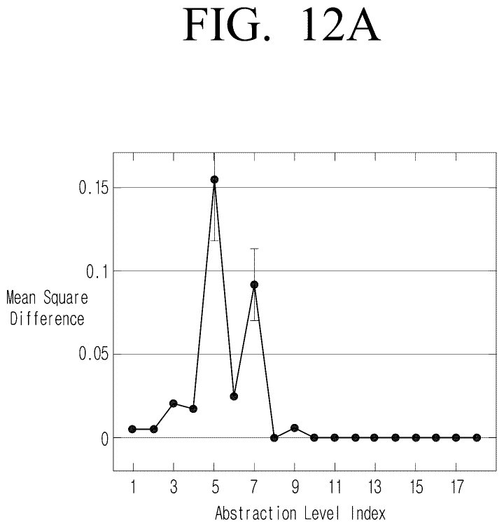

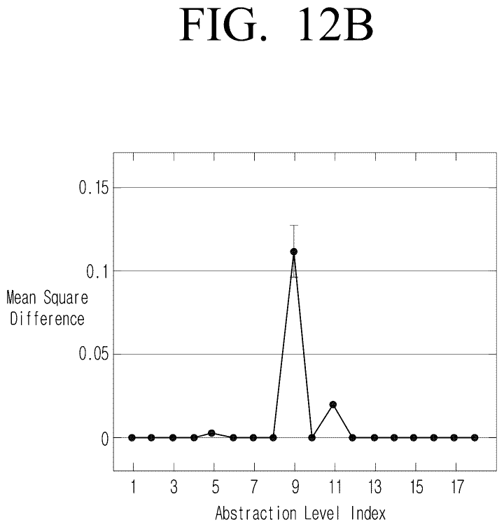

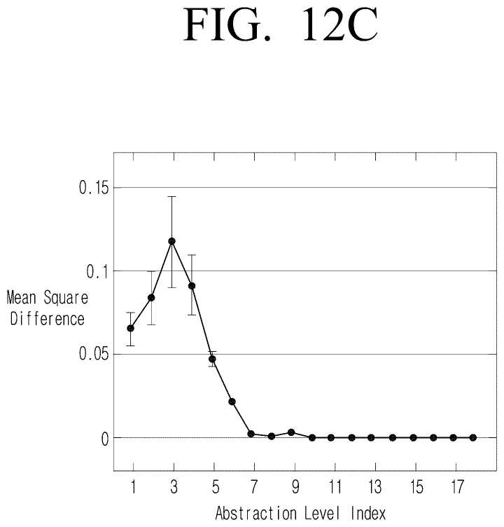

Analyses of intermediate latent spaces. The intermediate latent space that is learned by the present techniques was also analyzed. First, the property of employment of hierarchical representations is inspected. For this purpose, how the present techniques edit the StyleGAN features x for various face attributes is visualized in FIG. 12(12A, 12B, 12C). FIG. 12(12A, 12B, 12C) show results of experiments to analyse the intermediate latent space. The plots illustrate the mean square difference and variance between the input and edited StyleGAN features at different abstraction levels, where the left plot(1210) shows modification of expression, the middle plot(1220) shows modification of illumination and the right plot(1230) shows modification of pose. StyleGAN2-generated features are used, and the face parameters randomly swap for the manipulation. Notably, these changes for each attribute are sparse compared to the baseline method. This means that the present techniques selectively alter only the targeted parts of the multi-resolution input features. In other words, hierarchical learning is achieved by not disturbing unrelated details in multi-resolution GAN space. The indices for each attribute are compared which are manually determined by R. Abdal et al. These indices overlap with the present results as well.

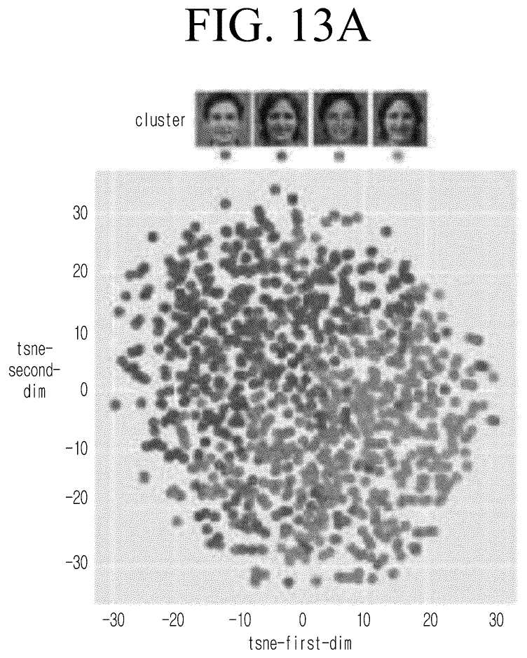

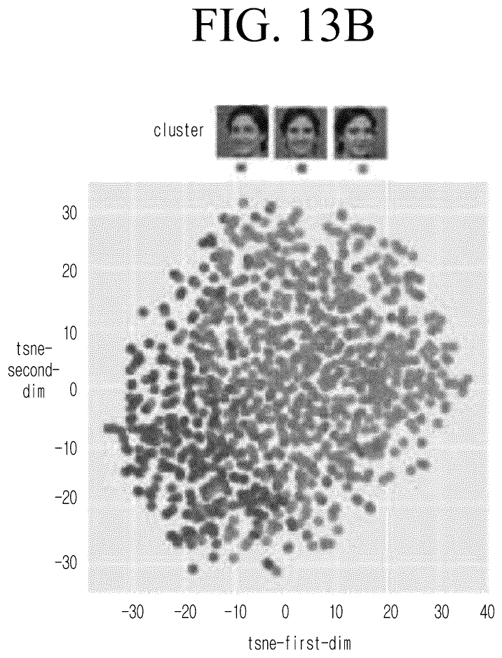

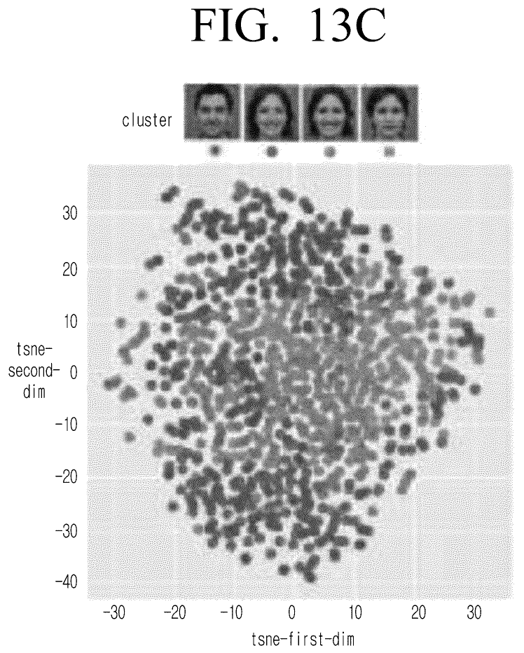

Second, the property of mutually exclusive and conceptually consistent representations is analysed. FIGS. 13A to 13C show results of experiments to analyse this property. In FIGS. 13A-13C, each sub-space [symbol] ᵢ in of intermediate latent space [symbol] is individually visualized using the t-SNE representations to demonstrate that the distribution of codes in each sub-space is conceptually consistent with that of the sub-spaces in the face parameter space [symbol] , for illumination (graph 1310 of FIG. 13A), pose (graph 1320 of FIG. 13B) and expression (graph 1330 of FIG. 13C). FIG. 13B shows the distribution of the latent codes. It can be seen that these latent codes are well-separated (i.e., mutually exclusive). This indicates that the intermediate latent space [symbol] =∪ᵢ₌₁^{M}, [symbol] ᵢ is spanned by multiple and independent sub-spaces. Next, each conceptual sub-space [symbol] ᵢ is inspected individually. For this purpose, the corresponding face parameter labels (either γ, R or θ∈p) for intermediate latent codes are used. Since these parameters are continuous, each sub-space of face parameters [symbol] ᵢ is clustered and use the representative cluster centers of each attribute as its sub-classes in FIGS. 13A to 13C. To enhance the interpretibility, these cluster centers are visuqlized for each attribute using StyleGAN2 model. The plots illustrate the space distribution of each conceptual sub-space Q; by coloring them with the corresponding sub-classes of each face attribute. The results show that the present techniques obtain a conceptually consistent latent space during self-supervised learning.

Thus, the present techniques provide a method to edit a pretrained GAN space for face editing. The present techniques differ from previous techniques in that an intermediate latent space is estimated by an encoder-decoder model whose latent codes can control manipulation of attribute and hierarchical information. The proposed pipeline performs this decomposition by relying solely on the reconstruction error during the mapping between the GAN space and face parameter space. Later, this intermediate space is used to optimize a GAN space controller for face editing. As a result, conceptual controllability of the present techniques for illumination, pose and expression is enhanced while the photo-realism of StyleGAN2 is preserved. Both qualitative and quantitative results indicate the superiority of the present techniques over baselines.

As noted above, the general method for generating modified images from input images using the ML model of the present techniques comprises: obtaining an image depicting at least one human face; and using the trained ML model to: determine, for the obtained image, visual features of one human face in the image; generate, using the determined visual features, at least one representation in vector space which encodes a specific attribute of the human face in the image; modify, in vector space, at least one generated representation; and generate, using the or each modified generated representation, a modified image. Various use cases are now described.

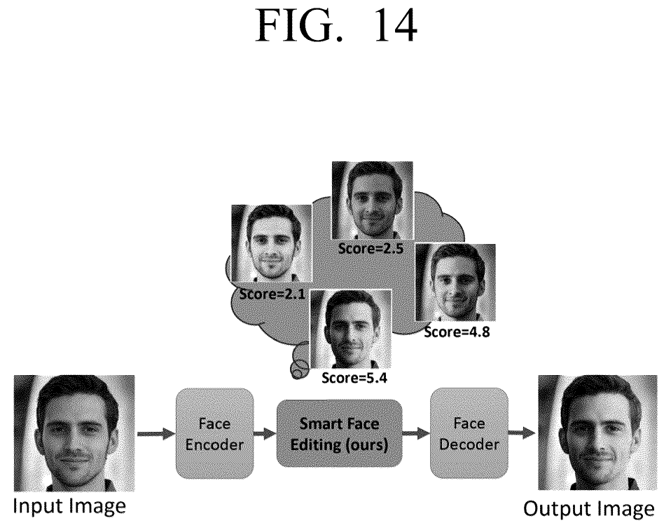

FIG. 14 is a schematic diagram of an example process to use the present techniques to generate modified images. Here, the method may further comprise: determining, using the ML model, at least one generated representation to be modified to improve an attractiveness score of the image of the human face. In this case, the ML model may determine, based on how the ML model has been trained, to determine how to modify an image to improve the attractiveness score of the human face in the image. Thus, the present techniques enable face manipulation to be performed without any user input or contextual guidance.

The trained ML model can automatically manipulate faces using an attractiveness score. The attractiveness score may be automatically calculated for different images that are manipulated using the trained ML model, and the image which is output by the trained ML model is one which has the best attractiveness score. Thus, as shown in FIG. 14, the trained ML model may generate multiple modified images, by modifying one or more attributes of an input image, and determine an attractiveness score of each modified image. Only the image with the highest attractiveness score may be output by the trained ML model. The attractiveness scores may be automatically calculated by the trained ML model, and the trained ML model may have learned how to assess attractiveness during the training process. For example, the ML model may have been trained using images which were labelled with human annotations of attractiveness.

The attractiveness score may be used by the trained ML model to determine which one or more attributes to manipulate, and how, in order to improve the score. Advantageously, the present techniques generate some intermediate outputs or estimates of how an image could be manipulated to improve an attractiveness score, and may learn over time which modifications/manipulations generally lead to improvements in the score. This enables the trained ML model to learn, during use, how to modify an input image to improve the attractiveness score, without requiring any user input.

The attractiveness score may be improved based on learned image preferences during training of the ML model, or during personalisation of the trained ML model for a user. The personalisation process may involve providing the trained ML model with images of a user which are representative of the user's preferences (in terms of one or more attributes). In this case, the personal image collection allows the ML model to estimate or learn the user's preferences. Advantageously, after the personalisation has been performed, this mitigates the need for further user input when using the trained and personalised ML model to generate modified images.

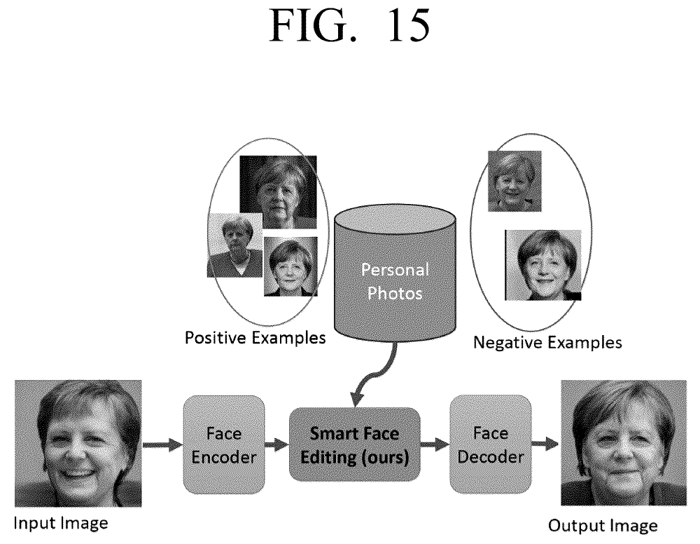

Thus, the attractiveness score may be improved based on learning a user's image preferences. FIG. 15 is a schematic diagram of another example process to use the present techniques to generate modified images. Here, the method may further comprise learning a user's image preferences by: receiving at least one positive sample image from the user indicative of image preferences the user likes; and/or receiving at least one negative sample image from the user indicative of image preferences the user dislikes. Thus, although the present techniques can operate without user involvement, as noted above, users can provide weak feedback to the trained ML model in order to manipulate input face images. A group of positive and negative examples may be provided by the user (e.g. from their photo gallery), using a user interface. These examples may be used by the trained ML model to manipulate input images based on the user's preferences, where the positive examples depict images that the user prefers or considers more attractive than the images of the negative examples. Thus, temporal user face preferences are captured via the positive and negative examples supplied by a user. The trained ML model may be used, on-device, to learn features of these examples, so that the preferences of the user may be learned.

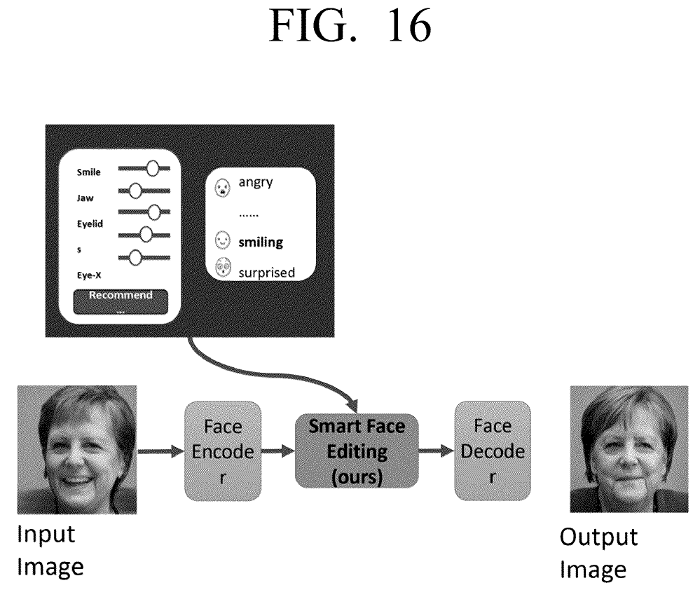

FIG. 16 is a schematic diagram of another example process to use the present techniques to generate modified images. Here, the method may further comprise: receiving, from a user, information on at least one specific attribute to be modified, and how the at least one specific attribute is to be modified. In this case, the feedback by a user is considered to be strong feedback (compared to the weak feedback in the process shown in FIG. 15). Thus, a user may be able to specify which attribute(s) is to be modified and how. Since the modifications take place in representation/vector space, which is not necessarily understandable by most users, the user may be provided with a graphical user interface that enables them to provide this information in a human-understandable manner.

The techniques shown in FIGS. 15 and 16 may be combined, which may allow a user to finetune their initial preferences (learned, by the model, from the positive and negative examples) using a user interface to further modify specific attributes.

As shown in FIG. 16, the user interface may be a graphical user interface that allows a user to modify human-understandable attributes, such as “smile”, “jaw”, “brightness”, “pose”, etc. The GUI may comprise any suitable mechanisms for a user to provide inputs, and the sliders in FIG. 16 are merely exemplary and non-limiting.

One example use case mentioned so far is that of altering a face in an image so that it has desired characteristics or attributes, such as a smile instead of a frown. Another example use case is that of altering a face so that it is anonymised. Instead of simply blurring a face in an image if the user's identity is to be hidden, a face in an image could be modified so that the face can be seen but the user's identity cannot be determined. Thus, the method may further comprise: receiving, from a user, an input indicating that face anonymisation is to be performed; wherein modifying, in vector space, at least one generated representation comprises modifying the at least one generated representation so that the generated modified image comprises an anonymised version of the original human face.

Another example use case is that of altering an image so that the style of the image and the face in the image is modified. For example, a user may capture a selfie image of themselves and want to modify the image so that it is, for example, in the style of a painting. Thus, the method may further comprise: receiving, from a user, an input indicating a preferred style; wherein modifying, in vector space, at least one generated representation comprises modifying the at least one generated representation so that the generated modified image is in the preferred style.

Typically, a user has a diverse range of images depicting faces. In some cases, the image may depict a single human face. In other cases, the image may depict at least two human faces. The user may be requested to select one of the at least two human faces to modify, and the model may process the selected human face. Alternatively, the model may recognise a specific user's face as one of the at least two human faces, and the model may process the recognised specific user's face.

It some cases, it may be desirable to modify more than one human face in an image. For example, in the case of an image depicting more than one human face, when a user wants to modify the levels of illumination of the faces in the image, it is important that the illumination of each of the faces in the image is modified, for consistency. Thus, the model may process each of the at least two human faces in an image. The model may modify, in vector space, the same at least one generated representation for each human face. Alternatively, the model modifies, in vector space, a different at least one generated representation for each human face.

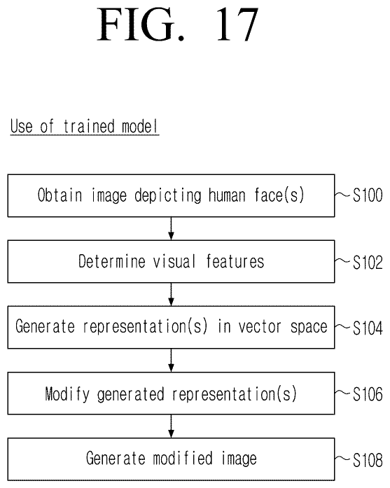

FIG. 17 is a flowchart showing example steps for generating modified images from input images using the trained machine learning, ML, model described herein. The method comprises: obtaining an image depicting at least one human face (step S100); and using the trained ML model to; determine, for the obtained image, visual features of one human face in the image (step S102); generate, using the determined visual features, at least one representation in vector space (step S104); modify, in vector space, at least one generated representation (S106); and generate, using the or each modified generated representation, a modified image (step S108).

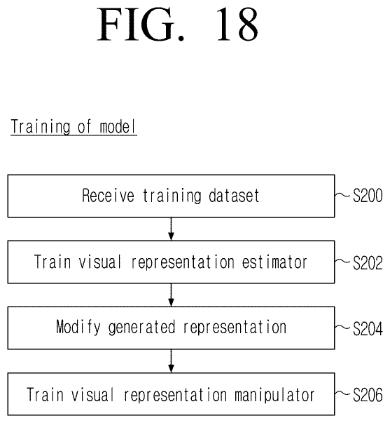

FIG. 18 is a flowchart showing example steps for training the ML model of the present techniques. The method comprises: receiving a training dataset comprising a plurality of images depicting human faces (S200); training, using the training dataset, a visual representation estimator module of the ML model to generate at least one representation in vector space which encodes a specific attribute of each human face in the images (S202); modifying at least one generated representation for each human face (S204); and training, using the training dataset and the modified at least one generated representation, a visual representation manipulator module of the ML model to generate a modified image (S206).

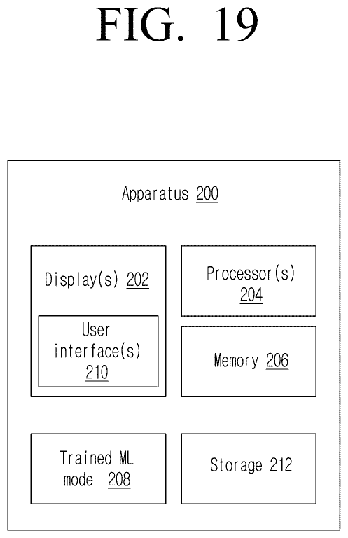

FIG. 19 is a block diagram of an apparatus 200 for using a trained machine learning, ML, model for generating modified images. The apparatus comprises a display 202, a processor 204 coupled to memory 206, and a trained ML model 208.

The apparatus 200 may be any one of: a smartphone, tablet, laptop, computer or com-puting device, virtual assistant device, a robot or robotic device, a robotic assistant, image capture system or device, an Internet of Things device, and a smart consumer device. It will be understood that this is a non-limiting and non-exhaustive list of apparatuses.

The at least one processor 204 may comprise one or more of: a microprocessor, a mi-crocontroller, and an integrated circuit. The memory 206 may comprise volatile memory, such as random access memory (RAM), for use as temporary memory, and/or non-volatile memory such as Flash, read only memory (ROM), or electrically erasable programmable ROM (EEPROM), for storing data, programs, or instructions, for example.

The processor 204 may be arranged to: obtain an image depicting at least one human face; use the trained ML model 208 to: determine, for the obtained image, visual features of one human face in the image; generate, using the determined visual features, at least one representation in vector space which encodes a specific attribute of the human face in the image; modify, in vector space, at least one generated representation; and generate, using the or each modified generated representation, a modified image. The modified image may be output on the display 202.

In the case that the obtained image depicts at least two human faces, the user may need to select a face to be modified. The processor 204 may be configured to: provide a user interface 210 on the display 202; and request, via the user interface 210, a user to select one of the at least two human faces in the image to modify.

As noted above, strong feedback from the user may be used to determine how to modify the input image. The processor 204 may be further configured to: provider a user interface 210 on the display; and request, via the user interface 210, information on at least one specific attribute to be modified and how the at least one specific attribute is to be modified. This user interface may be the same as that used to select a face to be modified, or different.

As noted above, weak feedback from the user may be used to determine how to modify the input image. The processor 204 may be further configured to: receive at least one positive sample image from the user indicative of image preferences the user likes and/or receive at least one negative sample image from the user indicative of image preferences the user dislikes; learn, using the ML model, the user's image preferences; and personalise the ML model to process images using the user's image preferences. The apparatus 200 may comprise storage 212. The sample images may be obtained from storage 212.

### REFERENCES

StyleGAN2—Tero Karras et al. Analyzing and improving the image quality of StyleGAN. In Proceedings of the IEEE/CVF conference on computer vision and pattern recognition, pages 8110-8119, 2020.
Ivan Anokhin et al. Image generators with conditionally-independent pixel synthesis. In Proceedings of the IEEE/CVF Conference on Computer Vision and Pattern Recognition, pages 14278-14287, 2021
A. Dosovitsky et al. An image is worth 16×16 words: Transformers for image recognition at scale. arXiv preprint arXiv:2010.11929, 2020.
InterfaceGAN (IG)—Yujun Shen, Jinjin Gu, Xiaoou Tang, and Bolei Zhou. Interpreting the latent space of gans for semantic face editing. In Proceedings of the IEEE/CVF conference on computer vision and pattern recognition, pages 9243-9252, 2020
GANSpace (GS)—Erik Harkonen, Aaron Hertzmann, Jaakko Lehtinen, and Sylvain Paris. Ganspace: Discovering interpretable gan controls. Advances in Neural Information Processing Systems, 33:9841-9850, 2020.
SeFa—Yujun Shen and Bolei Zhou. Closed-form factorization of latent semantics in gans. In Proceedings of the IEEE/CVF conference on computer vision and pattern recognition, pages 1532-1540, 2021
StyleRig (SR)—Ayush Tewari, Mohamed Elgharib, Gaurav Bharaj, Florian Bernard, Hans-Peter Seidel, Patrick Perez, Michael Zollhofer, and Christian Theobalt. Stylerig: Rigging stylegan for 3d control over portrait images. In Proceedings of the IEEE/CVF Conference on Computer Vision and Pattern Recognition, pages 6142-6151, 2020.
StyleFlow (SF)—Rameen Abdal, Peihao Zhu, Niloy J Mitra, and Peter Wonka. Styleflow: Attribute-conditioned exploration of stylegan-generated images using conditional continuous normalizing flows. ACM Transactions on Graphics (ToG), 40(3): 1-21, 2021
DPR model—Hao Zhou, Sunil Hadap, Kalyan Sunkavalli, and David W Jacobs. Deep single-image portrait relighting. In Proceedings of the IEEE/CVF international conference on computer vision, pages 7194-7202, 2019.
R. Abdal et al. Styleflow: Attribute-conditioned exploration of stylegangenerated images using conditional continuous normalizing flows. ACM Transactions on Graphics (ToG), 40(3): 1-21, 2021.

Those skilled in the art will appreciate that while the foregoing has described what is considered to be the best mode and where appropriate other modes of performing present techniques, the present techniques should not be limited to the specific configurations and methods disclosed in this description of the preferred embodiment. Those skilled in the art will recognise that present techniques have a broad range of applications, and that the embodiments may take a wide range of modifications without departing from any inventive concept as defined in the appended claims.

What is claimed is:

1. A computer-implemented method for generating modified images from input images using a trained machine learning, ML, model, the method comprising:
obtaining an image depicting at least one human face; and
using the trained ML model for:
determining, for the obtained image, visual features of one human face in the image;
generating, using the determined visual features, at least one representation in vector space which encodes a specific attribute of the human face in the image;
modifying, in vector space, one or more of the at least one generated representation; and
generating, using the or each modified generated representation, a modified image.

2. The method as claimed in claim 1 wherein the trained ML model comprises at least one transformer block, and wherein generating the at least one representation comprises:
processing the determined visual features using the at least one transformer block of the ML model, wherein each of the at least one transformer block generates a representation in vector space of a specific attribute.

3. The method as claimed in claim 2 wherein the ML model comprises a plurality of transformer blocks, and wherein generating at least one representation comprises:
using each of the plurality of transformer blocks to generate a representation of different specific attributes of the human face in the image.

4. The method as claimed in any claim 1 wherein modifying one or more of the at least one generated representation comprises using a transformer-based face editing module of the ML model to modify, in vector space, at least one specific attribute of the human face.

5. The method as claimed in claim 1 wherein obtaining an image comprises obtaining an image or a single frame of a video.

6. The method as claimed in claim 1 wherein obtaining an image comprises obtaining an image depicting a single human face.

7. The method as claimed in claim 1 wherein obtaining an image comprises obtaining an image depicting at least two human faces.

8. The method as claimed in claim 7 wherein the method comprises:
requesting a user to select one of the at least two human faces to modify; and
processing, using the ML model, the selected human face.

9. The method as claimed in claim 7 wherein the method comprises:
recognising, using the ML model, a specific user's face as one of the at least two human faces; and
processing, using the ML model, the recognised specific user's face.

10. The method as claimed in claim 7 wherein the method comprises separately processing, using the ML model, each of the at least two human faces.

11. The method as claimed in claim 10 further comprising, for each of the at least two human faces:
modifying, in vector space, a generated representation that represents one specific attribute.

12. The method as claimed in claim 10 further comprising:
modifying, in vector space, a generated representation that represents a different specific attribute for each of the human faces.

13. The method as claimed in claim 1 further comprising:
receiving, from a user, information on at least one specific attribute to be modified, and how the at least one specific attribute is to be modified.

14. The method as claimed in claim 1 further comprising:
determining, using the ML model, at least one generated representation to be modified to improve an attractiveness score of the image of the human face.

15. The method as claimed in claim 14 wherein the attractiveness score is improved based on learned image preferences during training of the ML model.

16. The method as claimed in claim 15 wherein the attractiveness score is improved based on learning a user's image preferences.

17. The method as claimed in claim 16 further comprising learning a user's image preferences by:
receiving at least one positive sample image of a human face from the user indicative of image preferences the user likes; and/or
receiving at least one negative sample image of a human face from the user indicative of image preferences the user dislikes; and
learning, using the ML model and the at least one received sample image, one or more features of the image of a human face indicative of image preferences.

18. The method as claimed in claim 1 further comprising:
receiving, from a user, an input indicating that face anonymisation is to be performed;
wherein modifying, in vector space, at least one generated representation comprises modifying the at least one generated representation so that the generated modified image comprises an anonymised version of the human face in the obtained image depicting at least one human face.

19. The method as claimed in claim 1 further comprising:
receiving, from a user, an input indicating a preferred style;
wherein modifying, in vector space, at least one generated representation comprises modifying the at least one generated representation so that the generated modified image is in the preferred style.

20. An apparatus for generating modified images from input images using a trained machine learning, ML, model, the apparatus comprising:
a display; and
at least one processor coupled to memory, for:
obtaining an image depicting at least one human face; and
using the trained ML model to:
determine, for the obtained image, visual features of one human face in the image;
generate, using the determined visual features, at least one representation in vector space which encodes a specific attribute of the human face in the image;
modify, in vector space, one or more of the at least one generated representation; and
generate, using the or each modified generated representation, a modified image.
